(19) United States
(12) Patent Application Publication
(10) Pub. No.: US 2022/0126222 A1
(43) Pub. Date: Apr. 28, 2022

(54) CONDENSING MECHANISM OF DISTILLED WATER DISPENSER

(71) Applicant: Ting-Mu Hsu, New Taipei City (TW)

(72) Inventor: Chun-Yi Wei, New Taipei City (TW)

(21) Appl. No.: 17/317,891

(22) Filed: May 12, 2021

(30) Foreign Application Priority Data
Oct. 26, 2020 (TW) 109214042

(51) Int. Cl. B01D 5/00

(52) U.S. Cl. CPC B01D 5/006; B01D 3/02; B01D 5/0006

(57) ABSTRACT

A driving mechanism includes a condensing coil and a fan set above a body of a distilled water dispenser. The condensing coil has multiple layers of spiral coil formed by winding a stainless steel tube in a spiral on each of different horizontal planes. The stainless steel tube has one end thereof terminating in a steam inlet port and connected to an inner tank of the body, and an opposite end thereof terminating in a distilled water outlet port. The fan is used to drive air to the condensing coil so that the steam in the stainless steel tube is cooled and condensed into distilled water. This can achieve the purpose of improving the condensation efficiency, shortening the time required to generate distilled water, reducing the temperature of the distilled water outlet, and avoiding the use of radiating fins.

### BACKGROUND OF THE INVENTION

### (a) Field of the Invention

The present invention relates to condensing mechanism technology and more particularly, to a condensing mechanism for a distilled water dispenser that is set above the body of a distilled water dispenser to condense the steam generated by the heating of the inner tank of the body into distilled water.

### (b) Description of the Prior Art

A known structure of a distilled water dispenser, such as shown in U.S. Pat. Nos. 4,342,623A, 6,280,577B1, 6,009,238A, has a barrel-shaped body, and a stainless steel inner tank is placed above the body. The inner tank has an electric heating tube set therein. An upper cover housing is detachably assembled on the top of the body. The upper cover housing is equipped with a condensing pipe and a fan. One end of the condensing pipe goes down and straight through the inner tank, and the other end of the condensing pipe is a water outlet that extends to the front of the upper cover housing. In this way, the water in the inner tank is heated through the electric heating tube, so that the steam generated after the water boils enters the condensing pipe, and at the same time, the fan blows air to the condensing pipe, so that the steam in the condensing pipe is condensed into distilled water, and then flows to the water outlet for users to collect.

Because the above-mentioned conventional condensing pipe has to be hidden in the limited space of the upper cover housing, the stainless steel tube is wound up and down in two turns, so the passage of the pipe is shorter. In order to improve its condensing efficiency, it had to increase the manufacturing cost by adding multiple radiating fins in the condensing pipe. However, due to the short passage of the condensing pipe that is wound up and down two turns, the steam quickly flows to the water outlet, causing problems such as insufficient condensation, waste of steam, and high temperature of the outlet water. Under no circumstances, only reduce the power of the electric heating tube or change it to intermittent heating, so that the amount of steam generated is less, and the condensing line has time to condense into distilled water, so it often takes a long time to generate enough distilled water. For this reason, how to improve the shortcomings of the above-mentioned conventional distilled water dispenser condensing pipe is the subject to be actively overcome by the present invention.

### SUMMARY OF THE INVENTION

The present invention has been accomplished under the circumstances in view. It is one object of the present invention to provide a condensing mechanism for distilled water dispenser, which uses a condensing coil that has multiple layers of spiral coil arranged on different horizontal planes in a continuous form, so that it can improve the condensation efficiency, shorten the time required to generate distilled water, reduce the temperature of the distilled water outlet, and avoid the use of radiating fins.

To achieve this and other objects of the present invention, a condensing mechanism is to be set above a body of a distilled water dispenser to condense the steam generated by the heating of an inner tank of the body into distilled water. The condensing mechanism comprises a condensing coil and a fan. The condensing coil comprises a first layer of spiral coil. The first layer of spiral coil is formed of a stainless steel tube that is continuously wound in a spiral on a first horizontal plane. The stainless steel tube has one end thereof terminating in a steam inlet port for connecting to the inner tank of the body, and an opposite end thereof terminating in a distilled water outlet port. The fan is arranged on the condensing coil, and used to drive air to the condensing coil so that the steam in the stainless steel tube is cooled and condensed into distilled water.

The condensing mechanism of the distilled water dispenser of the present invention can achieve the effects as follows:

1. Improve condensation efficiency: The condensing coil of the present invention is a structure that has multiple layers of spiral coil arranged on different horizontal planes in a continuous form. A longer stainless steel tube can be added to the limited space of the upper cover housing to make the condensation channel longer and easier to exchange heat with the fan's wind, thus improving the condensation efficiency.

2. Shorten the time required to produce distilled water: Based on the condensation function as described above, the distilled water dispenser can implement a high-power electric heating tube and set it to continuously heat the water in the inner tank, so that the water quickly boils to produce a large amount of steam into the condensing coil, and the steam continuously circulates in the condensing coil and is cooled down to produce distilled water, shortening the time required to produce distilled water.

3. Lower the temperature of distilled water: Based on the condensation function as described above, the present invention further extends the condensing passage, so the temperature of the distilled water reaching the outlet of the coil can be lower than that of the conventional water dispenser, allowing the user to quickly obtain distilled water with a temperature suitable for drinking.

4. Free radiating fins: Based on the condensation function as described above, where are already enough channels to condense into distilled water, so there is no need to install conventional radiating fins, which can reduce the process and manufacturing cost of manufacturing coils.

### BRIEF DESCRIPTION OF THE DRAWINGS

FIG. 1 is a schematic drawing, illustrating a condensing mechanism installed in a distilled water dispenser in accordance with the present invention.

FIG. 2 is an exploded view of the condensing coil and fan of the condensing mechanism of the preferred embodiment of the present invention.

FIG. 3 is an oblique top elevational view of the preferred embodiment of the condensing coil of the present invention.

FIG. 4 is a schematic top view of the preferred embodiment of the condensing coil of the present invention.

FIG. 5 is a schematic diagram of the state of use of the preferred embodiment of the condensing mechanism of the distilled water dispenser of the present invention.

### DETAILED DESCRIPTION OF THE PREFERRED EMBODIMENTS

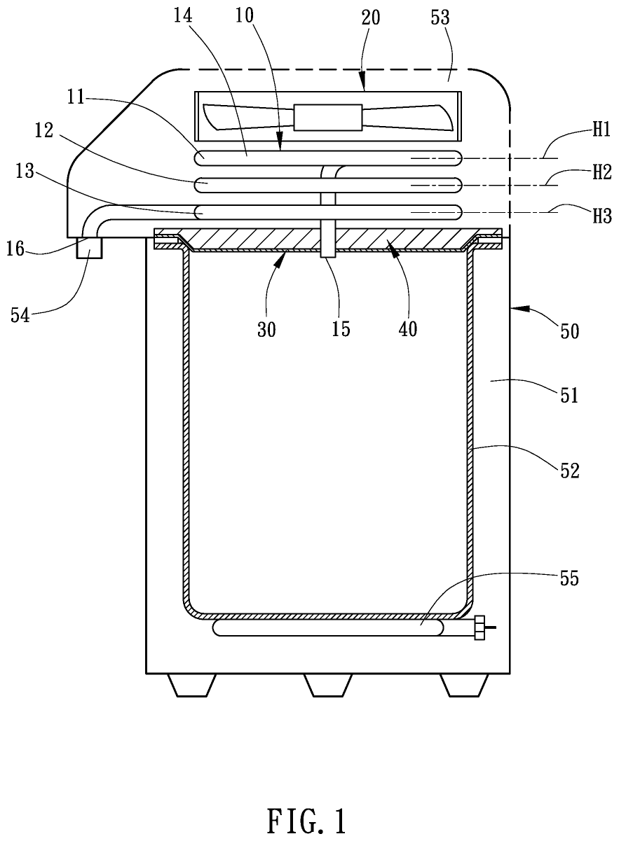

Referring to FIG. 1, a condensing mechanism in accordance with the present invention is set above the body 51 of a distilled water dispenser 50 to condense the steam generated by the heating of the inner tank 52 of the body 51 into distilled water. A preferred embodiment of the condensing mechanism comprises a condensing coil 10 and a fan 20. The condensing coil 10 and the fan 20 can be installed in an upper cover housing 53 of the distilled water dispenser 50, and the upper cover housing 53 is used to detachably assemble on the body 51.

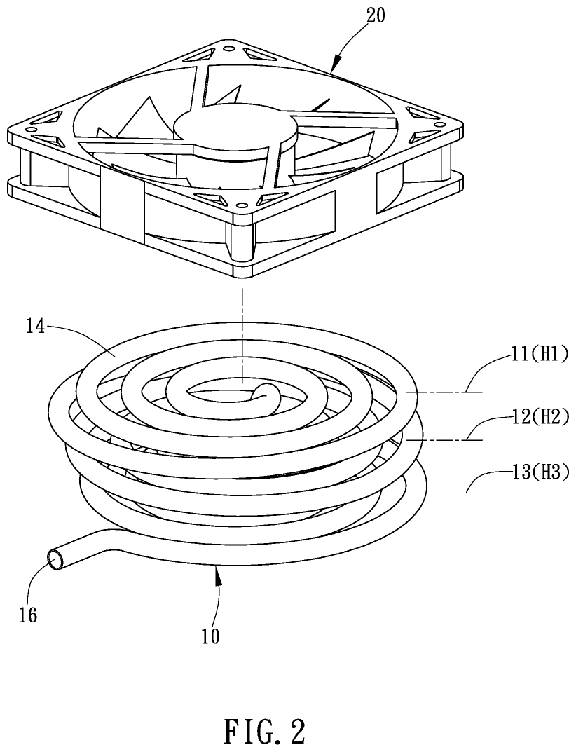

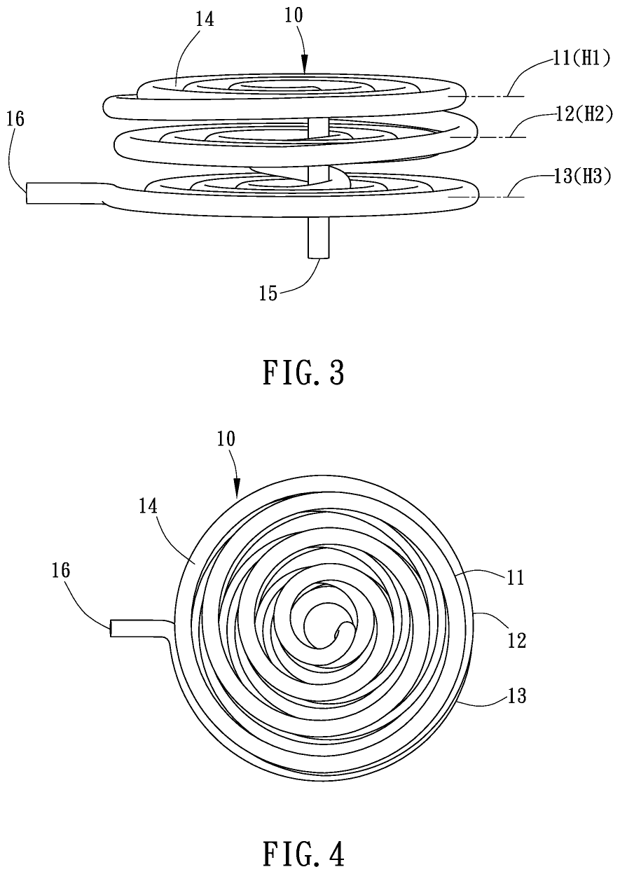

Refer to FIG. 2, FIG. 3 and FIG. 4 together, the condensing coil 10 mainly comprises a first layer of spiral coil 11 (that is, at least one of the three layers of spiral coil in the figure). The first layer of spiral coil 11 is formed by continuously winding a stainless steel tube 14 in a spiral shape on a first horizontal plane H1. One end of the stainless steel tube 14 is a steam inlet port 15 for connecting to an inner tank 52 in the body 51, and the other end of the stainless steel tube 14 is a distilled water outlet port 16 for connecting to the water outlet 54 of the distilled water dispenser 50. The water outlet 54 allows the generated distilled water to flow out.

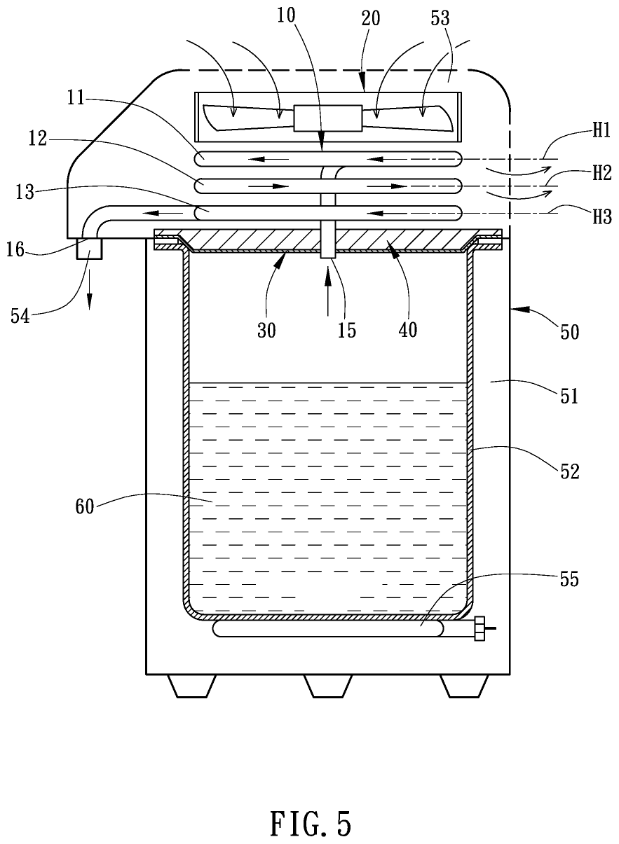

The steam inlet port 15 is preferably located at the center of the first layer of spiral coil 11. The first layer of spiral coil 11 is preferably continuously spirally wound from the center to the surrounding. The distilled water outlet port 16 preferably extends to one side of the condensing coil 10. The fan 20 is preferably an axial flow heat dissipation fan, which is arranged above the condensing coil 10, and is used to drive the air outside the upper cover housing 53 to flow toward the condensing coil 10 (as shown in FIG. 5), resulting in that the steam in the stainless steel tube 14 of the first layer of spiral coil 11 is cooled and condensed into the distilled water.

Based on the design that the first layer of spiral coil 11 of the condensing coil 10 is formed by continuously winding the stainless steel tube 14 in a spiral shape on the first horizontal plane H1, the condensing mechanism of the present invention can extend the vapor condensation passage of the condensing coil 10 in the limited space inside the upper cover housing 53. Therefore, the stainless steel tube 14 of the first layer of spiral coil 11 has a longer time to exchange heat with the cold air driven by the fan 20, so that the steam in the pipeline is condensed into distilled water with a lower temperature.

Refer to FIG. 2 to FIG. 4 again. In order to improve the distilled water condensing efficiency, the condensing coil 10 of the present invention can be implemented to have a second layer of spiral coil 12 or a third layer of spiral coil 13. The second layer of spiral coil 12 is formed by the above-mentioned stainless steel tube 14. After the continuous winding on the first horizontal plane H1 is completed, the stainless steel tube 14 is extended to a second horizontal plane H2 and then continuously wound in a spiral shape on the second horizontal plane H2, so that the second layer of spiral coil 12 is located below the first layer of spiral coil 11. The second layer of spiral coil 12 is preferably continuously spirally wound from the surrounding toward the center, and the distilled water outlet port 16 can be implemented in the second layer of spiral coil 12 (not shown).

Refer to FIG. 2 to FIG. 4 again. Similarly, when the condensing coil 10 is to be wound into a third layer of spiral coil 13, the third layer of spiral coil 13 is also formed of the stainless steel tube 14. After the stainless steel tube 14 is continuously wound on the second horizontal plane H2, it is extended to a third horizontal plane H3 and is spirally wound continuously on third horizontal plane H3, so that the third layer of spiral coil 13 is located below the second layer of spiral coil 12. The third layer of spiral coil 13 is preferably continuously spirally wound from the center to the surrounding. The distilled water outlet port 16 extends in the direction of continuous spiral winding from the center to the surrounding direction, exactly to one side of the third layer of spiral coil 13. In the same way, the present invention can be implemented to have a fourth layer or the Nth layer of spiral coil as required, without departing from the spirit of the present invention.

Through the above-mentioned structural design extending to the second layer of spiral coil 12 and even the third layer of spiral coil 13, the present invention can fit a stainless steel tube 14 with a length of up to 3 meters in the upper cover housing 53 of the existing distilled water dispenser 50. Therefore, there are enough heat dissipation channels and circulation time to condense the steam into distilled water at a lower temperature. Based on this condensation effect, referring to FIG. 4 again, the bottom of the inner tank 52 of the distilled water dispenser 50 can implement a high-power electric heating tube 55, and it is set to continuously heat the water 60 in the inner tank 52 to boil the water 60 to produce a large amount of steam into the condensing coil 10, and the produced steam continuously circulates in the condensing coil 10 and is cooled down to generate distilled water. Since the present invention can increase the power of the electric heating tube 55 and continue heating, it can generate more distilled water at a lower temperature in a shorter time, thereby improving the problem of slow water production and excessive temperature in the conventional distilled water dispenser.

Referring to FIG. 1 again, the present invention can further implement a bottom plate 30 and a heat insulation layer 40. The bottom plate 30 is a stainless steel plate used to cover the upper opening of the inner tank 52. The heat insulation layer 40 is arranged on the bottom plate 30, and is composed of materials that can insulate heat transfer, such as an insulation board, insulation cotton or an internal vacuum plate, so that the heat of the inner tank 52 will not be transferred to the condensing coil 10. The condensing coil 10 is arranged on the heat insulation layer 40, and one end of the stainless steel tube 14 passes through the heat insulation layer 40 and the bottom plate 30, so that the steam inlet port 15 is located below the bottom plate 30. Thereby, the condensing coil 10 and the fan 20 are arranged in the upper cover housing 53, so that the bottom plate 30 is located under the upper cover housing 53. When the upper cover housing 53 is combined with the body 51 of the distilled water dispenser 50, the bottom plate 30 closes the inner tank 52, and the steam generated by the inner tank 52 directly enters the condensing coil 10 through the steam inlet port 15.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A condensing mechanism set above a body of a distilled water dispenser to condense the steam generated by the heating of an inner tank of said body into distilled water, the condensing mechanism comprising:
a condensing coil comprising a first layer of spiral coil and a second layer of spiral coil, said first layer of spiral coil being formed of a stainless steel tube continuously wound in a spiral on a first horizontal plane, said second layer of spiral coil being formed of said stainless steel tube by extending said stainless steel tube to a second horizontal plane after formation of said first layer of spiral coil on said first horizontal plane and then continuously winding said stainless steel tube in a spiral on said second horizontal plane, said second layer of spiral coil being located below said first layer of spiral coil, said stainless steel tube having one end thereof terminating in a steam inlet port for connecting to said inner tank of said body and an opposite end thereof terminating in a distilled water outlet port; and
a fan arranged on said condensing coil, used to drive air to said condensing coil so that the steam in said stainless steel tube is cooled and condensed into distilled water.

2. The condensing mechanism as claimed in claim 1, wherein said steam inlet port is located at the center of said first layer of spiral coil; said first layer of spiral coil is continuously spirally wound from the center to the surrounding.

3. The condensing mechanism as claimed in claim 2, wherein said second layer of spiral coil is continuously spirally wound from the surrounding to the center.

4. The condensing mechanism as claimed in claim 3, wherein said steam inlet port is located in said first layer of spiral coil; said distilled water outlet port is located in said second layer of spiral coil.

5. The condensing mechanism as claimed in claim 4, wherein said condensing coil further comprises a third layer of spiral coil, said third layer of spiral coil being formed of said stainless steel tube by extending said stainless steel tube from said second horizontal plane to a third horizontal plane after formation of said second layer of spiral coil on said second horizontal plane and then continuously winding said stainless steel tube in a spiral on said third horizontal plane, said third layer of spiral coil being located below said second layer of spiral coil, said distilled water outlet port being located in said third layer of spiral coil to replace the distilled water outlet port of said second layer of spiral coil.

6. The condensing mechanism as claimed in claim 5, wherein said third layer of spiral coil is continuously spirally wound from the center to the surrounding.

7. The condensing mechanism as claimed in claim 1, wherein said fan is an axial flow heat dissipation fan.

8. The condensing mechanism as claimed in claim 1, further comprising a bottom plate and a heat insulation layer, said bottom plate being a stainless steel plate used to cover an upper opening of said inner tank, said heat insulation layer being arranged on said bottom plate; said condensing coil is arranged on said heat insulation layer; said stainless steel tube has one end thereof passing through said heat insulation layer and said bottom plate, so that said steam inlet port is located below said bottom plate.

9. The condensing mechanism as claimed in claim 8, further comprising an upper cover housing detachably assembled on said body; said condensing coil and said fan are installed in said upper cover housing; said bottom plate is located below said upper cover housing.
